(19) United States
(12) Patent Application Publication
(10) Pub. No.: US 2008/0253509 A1
(43) Pub. Date: Oct. 16, 2008

(54) Acquisition Parameter Optimization For Csct

(75) Inventors: Jens-Peter Schlomka, Hamburg (DE); Udo Van Stevendaal, Ahrensburg (DE); Axel Thran, Hamburg (DE); Rudiger Grewer, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,404

(22) PCT Filed: Oct. 4, 2006
(86) PCT No.: PCT/IB06/53630

§ 371 Date: Apr. 7, 2008

(30) Foreign Application Priority Data
Oct. 6, 2005 (EP) 05109304.5

(51) Int. Cl. G01N 23/04

(52) U.S. Cl. 378/19

(57) ABSTRACT

Whereas the CT image can be acquired in a single revolution, the CSCT image acquisition may require several revolutions. According to an exemplary embodiment of the present invention, a CT/CSCT apparatus may be provided which uses CT data acquired during the first revolution to optimize acquisition parameters for the subsequent revolutions. Furthermore, projection data acquired with a pre-scanner may also be used for determining current modulation or setting an optimum voltage for the subsequent CSCT scan.

The invention relates to the field of x-ray imaging. In particular, the invention relates to a computer tomography apparatus for examination of an object of interest, to a method of examining an object of interest with a computer tomography apparatus, to an image processing device, a computer-readable medium and a program element.

Over the past several years, x-ray baggage inspection has evolved from simple x-ray imaging systems that were completely dependent on an interaction by an operator to more sophisticated automatic systems that can automatically recognise certain types of materials and trigger an alarm in the presence of dangerous materials.

An imaging technique based on coherently scattered x-ray photons is the so-called “coherent scatter computed tomography” (CSCT). CSCT is a technique that generates images of the low angle scatter properties of an object of interest. These scatter properties depend on the molecular structure of the object, making it possible to produce material-specific maps of each component. The dominant component of low angle scatter is coherent scatter. Since coherent scatter spectra depend on the atomic arrangement of the scattering sample, coherent scatter computed tomography is a sensitive technique for imaging spatial variations and molecular structure of baggage or biological tissue across a two-dimensional object section.

A narrow fan-beam with small divergence in the out of fan plane direction penetrates the object. The transmitted radiation as well as the radiation scattered in the direction out of the fan plane is detected with a two-dimensional detector unit.

The coherent scatter process is a rather unlikely event and therefore a high photon flux or elongated measurement times are required. In comparison, data acquisition of a CT image requires less time or X-ray flux.

It may be desirable to provide for an improved acquisition of CSCT data to speed up the CSCT material analysis process.

According to an exemplary embodiment of the present invention, a computer tomography apparatus for examination of an object of interest may be provided, the computer tomography apparatus comprising a radiation source adapted for moving along a source path and for emitting an electromagnetic radiation beam to the object of interest, a detector unit adapted for acquiring separately scattered and transmitted radiation data from the object of interest, and a calculation unit adapted for performing an optimization of an acquisition parameter of a subsequent second data acquisition on the basis of radiation data acquired during a first data acquisition.

Therefore, a computer tomography apparatus may be provided, which uses previous knowledge of the object of interest acquired during a pre-scan or during the first revolution of the CSCT scanner to optimize acquisition parameters, like, for example, generator voltage and x-ray tube current for subsequent revolutions of the gantry.

This may reduce exposure time while maintaining the reconstruction quality.

According to another exemplary embodiment of the present invention, the first data acquisition is performed during a full or partial first rotation of the radiation source using the detection unit.

According to another exemplary embodiment of the present invention, wherein the acquisition parameter corresponds to a current of the radiation source, and wherein the computer tomography apparatus is adapted for modulating a flux output of the radiation source on the basis of the acquired radiation data, resulting in an optimized flux modulation.

In other words, an optimized modulation of the source flux (such as a tube current) is performed during the primary data acquisition. The current modulation is performed on the basis of information acquired during a pre-scan (which may be performed by the main CT scanner module or by a so-called pre-scanner) immediately before the main data acquisition process.

According to another exemplary embodiment of the present invention, the optimization of the acquisition parameter of the subsequent second data acquisition is performed on the basis of at least one of projection data resulting from the first data acquisition and reconstructed image data resulting from the first data acquisition.

Therefore, according to this exemplary embodiment of the present invention, the pure projection data may be used for the scan parameter optimization of subsequent scans. Alternatively, or additionally, reconstructed image data (which is reconstructed from the pre-scan data acquired before the second data acquisition) may be used for scan parameter optimization.

According to another exemplary embodiment of the present invention, the flux output modulation is performed such that a maximum value is reached when the object of interest is viewed from a direction with maximum absorption.

In other words, the current modulation may, according to this exemplary embodiment of the present invention, correspond to absorption properties of the object of interest at the respective source direction. For example, if the radiation source emits the beam into a direction of high absorption, then the x-ray tube current is high, and when the radiation source emits the beam into a direction with low absorption, then the corresponding x-ray tube current is low.

According to another exemplary embodiment of the present invention, the calculation unit is adapted for calculating an optimum flux output modulation on the basis of a cross-sectional image of attenuation properties of the object of interest.

Therefore, according to this exemplary embodiment of the present invention, the radiation data acquired during the first data acquisition may be reconstructed and analyzed with respect to its attenuation properties. On the basis of this analysis, the current modulation is optimized.

According to another exemplary embodiment of the present invention, the computer tomography apparatus further comprises a pre-scanner for performing a pre-scan of the object of interest, resulting in pre-scan projection data, wherein the acquisition parameter optimization is based on the pre-scan projection data.

In other words, an extra scanning unit is used for performing the first data acquisition before data acquisition system before doing the main scan.

According to another exemplary embodiment of the present invention, the pre-scanner is a multi-view pre-scanner.

According to another exemplary embodiment of the present invention, the cross-sectional image is exactly determined on the basis of CT acquisition data acquired during a single rotation of the radiation source.

According to another exemplary embodiment of the present invention, the computer tomography apparatus comprises a pre-scanner adapted for measuring transmission image data of the object of interest, wherein the radiation data acquired during the first data acquisition comprises the transmission image data.

According to another exemplary embodiment of the present invention, the computer tomography apparatus further comprises a high-voltage generator, wherein the acquisition parameter corresponds to a voltage of the high-voltage generator, and wherein the computer tomography apparatus is adapted for determining the voltage on the basis of the acquired radiation data, resulting in an optimized voltage for the subsequent second data acquisition.

For example, according to this exemplary embodiment of the present invention, the voltage may be calculated and changed prior to the beginning of the second data acquisition (which may be, for example, the scan of a slice).

According to another exemplary embodiment of the present invention, the calculation unit is adapted for calculating an approximate average attenuation on the basis of a single transmission image, and for calculating the optimized voltage for the subsequent second data acquisition on the basis of the approximate average attenuation.

Furthermore, a multi-view pre-scanner may be used, which may provide for an accurate determination of the voltage.

According to another exemplary embodiment of the present invention, the computer tomography apparatus is adapted as a cone-beam coherent scatter computed tomography apparatus or a direct tomography coherent scatter computed tomography apparatus.

The x-ray tomography apparatus according to the invention may be configured as one of the group consisting of a baggage inspection apparatus, a medical application apparatus, a material testing apparatus and a material science analysis apparatus. However, the most preferred field of application of the invention may be baggage inspection, since the refined functionality of the invention may allow for a secure and reliable analysis of the content of a baggage item allowing to detect suspicious content, even allowing to determine the type of material inside such a baggage item. The invention creates a high-quality automatic system that can automatically recognize certain types of materials and, if desired, trigger an alarm in the presence of dangerous materials. Such an inspection system may, for example, be used in airports.

Furthermore, the computer tomography apparatus according to an exemplary embodiment of the present invention, may be configured as one of the group consisting of an energy-resolved coherent scatter computed tomography apparatus and a non-energy resolved coherent scatter computed tomography apparatus.

According to another exemplary embodiment of the present invention, the acquisition parameter corresponds to a scan time of the subsequent second data acquisition, wherein the optimization of the acquisition parameter of the subsequent second data acquisition is performed on the basis of a transmitted photon flux.

Furthermore, the scan time may be defined by multiplying the scan time of a single revolution with the number of revolutions used for the subsequent second data acquisition.

According to another exemplary embodiment of the present invention, the scan time is determined on the basis of a pre-calculated scheme.

According to another exemplary embodiment of the present invention, the acquisition parameter corresponds to a scan time of the subsequent second data acquisition, wherein the optimization of the acquisition parameter of the subsequent second data acquisition is performed on the basis of a scatter photon flux.

According to another exemplary embodiment of the present invention, the scatter photon flux is monitored during the first revolution of the gantry and from the scatter photon flux the required number of revolution is calculated.

According to another exemplary embodiment of the present invention, the scatter photon flux is stored for each measured scatter projection and added cumulatively for each subsequent revolution until enough photons are recorded.

According to another exemplary embodiment of the present invention, a method of examining an object of interest with a computer tomography apparatus may be provided, the method comprising the steps of emitting, by a radiation source, an electromagnetic radiation beam to the object of interest, acquiring by a detector unit radiation data from the object of interest, performing, by a calculation unit, an optimization of an acquisition parameter of a subsequent second data acquisition on the basis of radiation data acquired during the first data acquisition, and acquiring, by a detector unit and during a second data acquisition, separately scattered and transmitted radiation data from the object of interest.

It is believed that this may allow for an improved acquisition of CSCT data.

According to another exemplary embodiment of the present invention, an image processing device for examining an object of interest with a computer tomography apparatus may be provided, the image processing device comprising a memory for storing radiation data acquired, during a first data acquisition, from the object of interest. Furthermore, the image processing device comprises a calculation unit adapted for performing an optimization of an acquisition parameter of a subsequent second data acquisition on the basis of the acquired radiation data.

According to another exemplary embodiment of the present invention, a computer-readable medium may be provided, in which a computer program for examining an object of interest with a computer tomography apparatus is stored which, when being executed by a processor, is adapted to carry out the above-mentioned method steps.

The present invention also relates to a program element of examining an object of interest, which, when being executed by a processor, is adapted to carry out the above-mentioned method steps. The program element may be stored on the computer-readable medium and may be loaded into working memories of a data processor. The data processor may thus be equipped to carry out exemplary embodiments of the methods of the present invention. The computer program may be written in any suitable programming language, such as, for example, C++ and may be stored on a CD-ROM. Also, the computer program may be available from a network, such as the WorldWideWeb, from which it may be downloaded into image processing units or processors, or any suitable computers.

It may be seen as the gist of an exemplary embodiment of the present invention, that previous knowledge of the object of interest is acquired during a pre-scan or during the first revolution of the CSCT-scanner in order to optimize acquisition parameters, such as generator voltage, or radiation source flux output for subsequent revolutions of the gantry and the number of total gantry revolutions used for the scatter data acquisition.

These and other aspects of the present invention will become apparent from and elucidated with reference to the embodiments described hereinafter.

Exemplary embodiments of the present invention will be described in the following, with reference to the following drawings.

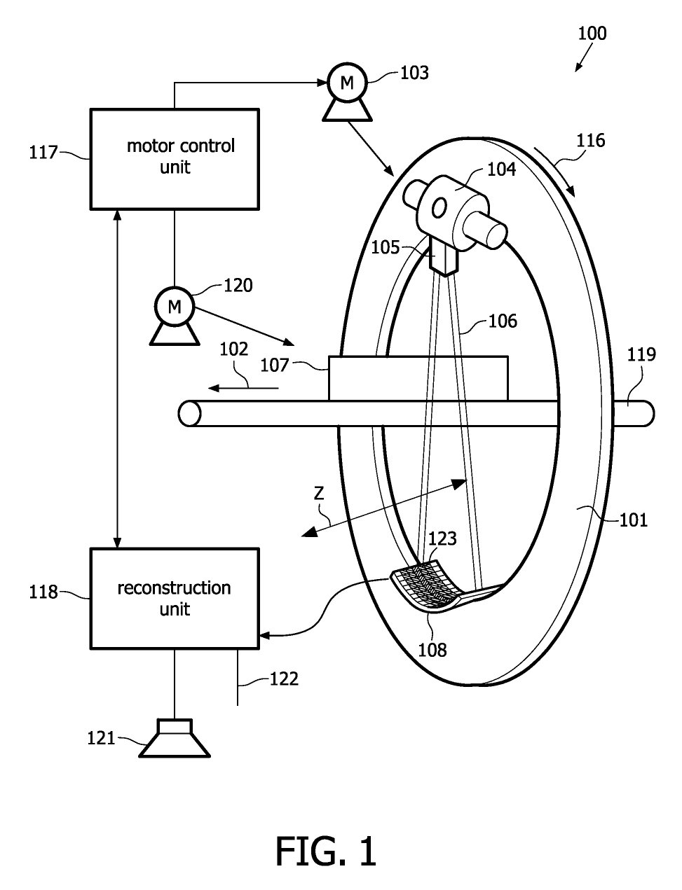

FIG. 1 shows a simplified schematic representation of a CSCT scanner system according to an exemplary embodiment of the present invention.

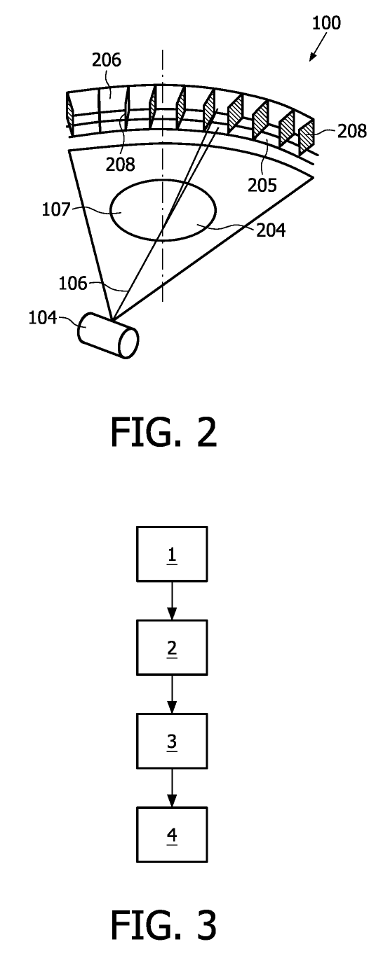

FIG. 2 shows a schematic representation of a geometry for energy-resolved CSCT according to an exemplary embodiment of the present invention.

FIG. 3 shows a flow-chart of an exemplary embodiment of a method of examination of an object of interest according to the present invention.

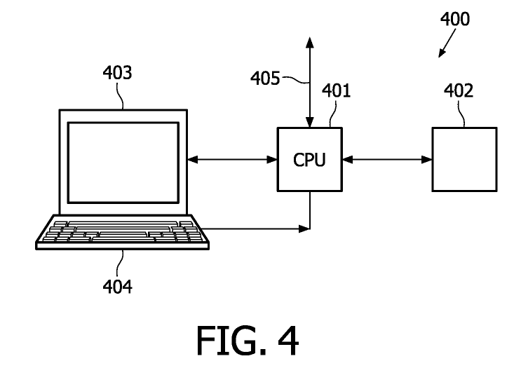

FIG. 4 shows an exemplary embodiment of an image processing device according to the present invention, for executing an exemplary embodiment of a method in accordance with the present invention.

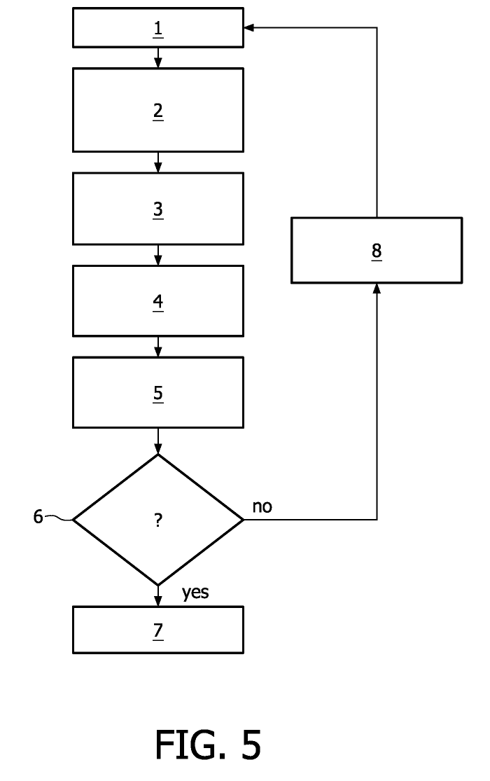

FIG. 5 shows a flow-chart of another exemplary embodiment of a method of examination of an object of interest according to the present invention.

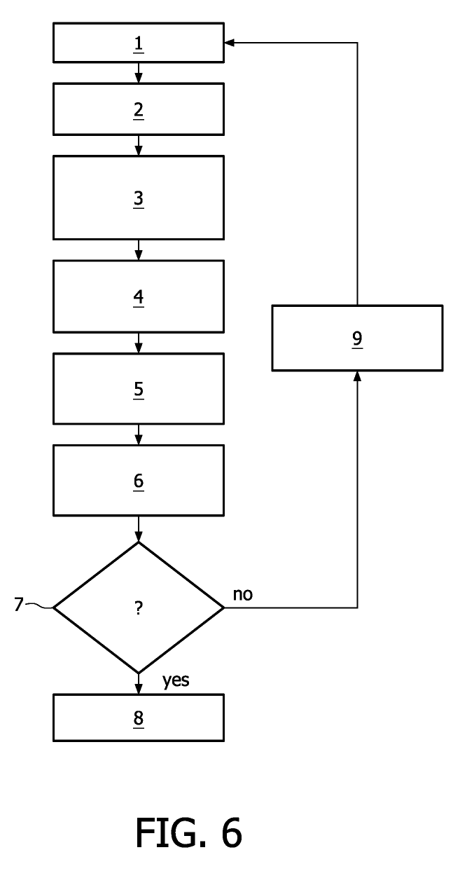

FIG. 6 shows a flow-chart of another exemplary embodiment of a method of examination of an object of interest according to the present invention.

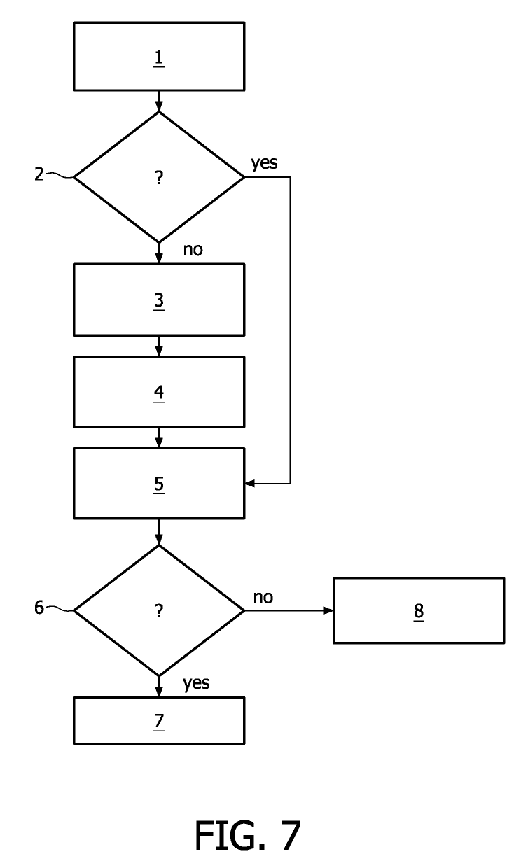

FIG. 7 shows a flow-chart of another exemplary embodiment of a method of examination of an object of interest according to the present invention.

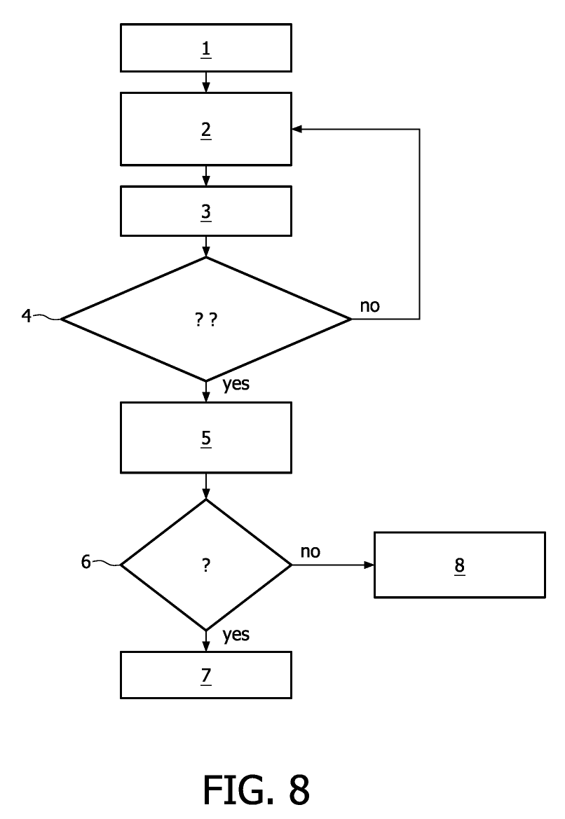

FIG. 8 shows a flow-chart of another exemplary embodiment of a method of examination of an object of interest according to the present invention.

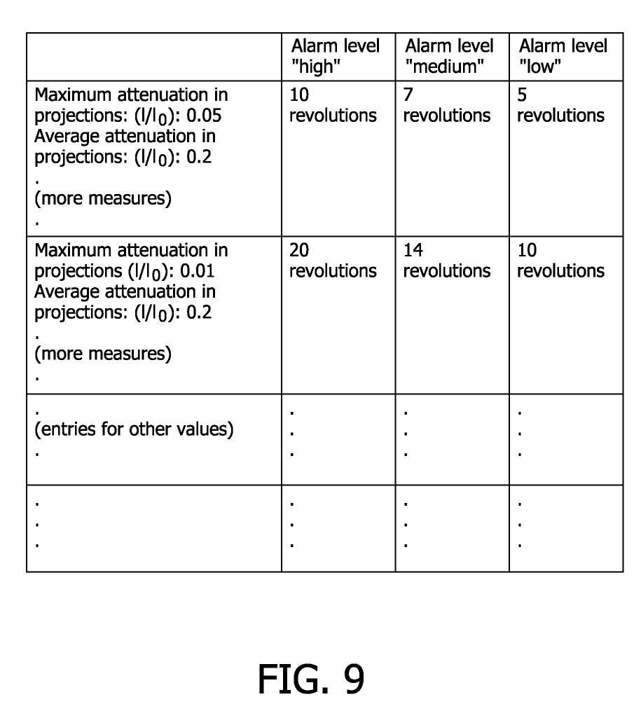

FIG. 9 shows an exemplary embodiment of a table for the determination of the scan time depending on the measured attenuation in the projections according to the present invention.

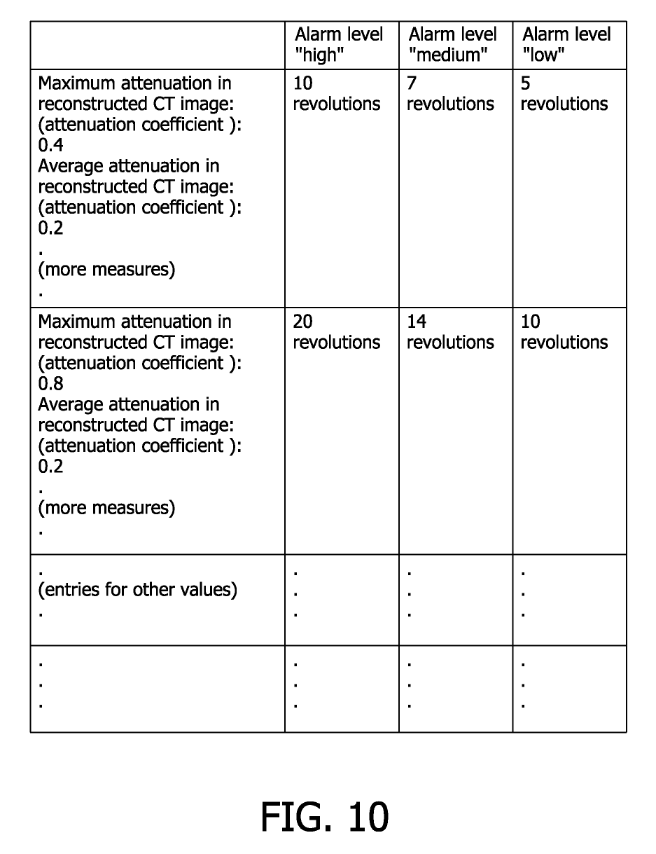

FIG. 10 shows an exemplary embodiment of a table for the determination of the scan time depending on the measured attenuation coefficients in the reconstructed image according to the present invention.

The illustration in the drawings is schematically. In different drawings, similar or identical elements are provided with the same reference numerals.

FIG. 1 shows an exemplary embodiment of a CT/CSCT scanner system according to an exemplary embodiment of the present invention. With reference to this exemplary embodiment, the present invention will be described for the application in the field of baggage inspection. However, it should be noted that the present invention is not limited to this application, but may also be applied in the field of medical imaging, or other industrial applications, such as material testing.

The computer tomography apparatus 100 depicted in FIG. 1 is a fan-beam CT/CSCT scanner. The CT/CSCT scanner depicted in FIG. 1 comprises a gantry 101, which is rotatable around a rotational axis 102. The gantry 101 is driven by means of a motor 103. Reference numeral 104 designates a source of radiation such as an X-ray source, which, according to an aspect of the present invention, emits a polychromatic radiation.

Reference numeral 105 designates an aperture system which forms the radiation beam emitted from the radiation source to a fan-shaped radiation beam 106. The fan-beam 106 is directed such that it penetrates an object of interest 107 arranged in the centre of the gantry 101, i.e. in an examination region of the CT scanner, and impinges onto the detector 108. As may be taken from FIG. 1, the detector 108 is arranged on the gantry 101 opposite to the source of radiation 104, such that the surface of the detector 108 is at least partially illuminated by the fan-beam 106. The detector 108, which is depicted in FIG. 1, comprises a plurality of detector elements 123 each capable of detecting, in an energy-resolving manner, X-rays or individual photons which have penetrated the object of interest 107.

During a scan of the object of interest 107, the source of radiation 104, the aperture system 105 and the detector 108 are rotated along the gantry 101 in the direction indicated by arrow 116. For rotation of the gantry 101 with the source of radiation 104, the aperture system 105 and the detector 108, the motor 103 is connected to a motor control unit 117, which is connected to a calculation or determination unit 118.

In FIG. 1, the object of interest 107 may be an item of baggage or a patient which is disposed on a conveyor belt 119. During the scan of the object of interest 107, while the gantry 101 rotates around the item of baggage 107, the conveyor belt 119 displaces the object of interest 107 along a direction parallel to the rotational axis 102 of the gantry 101. By this, the object of interest 107 is scanned along a helical scan path. The conveyor belt 119 may also be stopped during the scans to thereby measure single slices. Instead of providing a conveyor belt 119, for example, in medical applications where the object of interest 107 is a patient, a movable table may be used. However, it should be noted that in all of the described cases it may also be possible to perform other scan paths.

The detector 108 may be connected to the calculation unit 118. The calculation unit 118 may receive the detection result, i.e. the read-outs from the detector elements 123 of the detector 108 and may determine a scanning result on the basis of the read-outs. Furthermore, the calculation unit 118 communicates with the motor control unit 117 in order to coordinate the movement of the gantry 101 with motors 103 and 120 with the conveyor belt 119.

The calculation unit 118 may be adapted for performing an optimization of an acquisition parameter of a subsequent second data acquisition on the basis of the acquired radiation data, according to an exemplary embodiment of the present invention. A reconstructed image generated by the calculation unit 118 may be output to a display (not shown in FIG. 1) via an interface 122.

The calculation unit 118 may be realized by a data processor to process read-outs from the detector elements 123 of the detector 108.

Furthermore, as may be taken from FIG. 1, the calculation unit 118 may be connected to a loudspeaker 121, for example, to automatically output an alarm in case of the detection of suspicious material in the item of baggage 107.

The computer tomography apparatus 100 for examination of the object of interest 107 includes the detector 108 having the plurality of detecting elements 123 arranged in a matrix-like manner, each being adapted to detect X-rays. Furthermore, the computer tomography apparatus 100 comprises the determination unit or reconstruction unit 118 adapted for reconstructing an image of the object of interest 107.

The computer tomography apparatus 100 comprises the X-ray source 104 adapted to emit X-rays to the object of interest 107. The collimator 105 provided between the electromagnetic radiation source 104 and the detecting elements 123 is adapted to collimate an electromagnetic radiation beam emitted from the electromagnetic radiation source 104 to form a fan-beam. The detecting elements 123 form a multi-slice detector array 108.

FIG. 2 shows a schematic representation of a geometry for energy-resolved CSCT. The CSCT apparatus 100 has an x-ray source 104 for emitting an x-ray beam which is guided through a slit collimator (not shown in FIG. 2) to form a primary fan-beam 106 impinging on the object of interest 107 located in an object region 204. A multi-line detector 205, 206, 208 is constituted by a central detection element 205 (i.e. a central row for the detection of x-rays of the fan-beam transmitted through the object 107), and by energy-resolving detection elements 206 (i.e. energy-resolving detector lines).

Thus, FIG. 2 shows a geometry for pure energy-resolved CSCT. The central detection line 205 measures transmitted radiation, whereas the one or more detection lines 206 are configured to perform energy-resolving measurements.

The combined CT and scatter information may be used for material identification in the case of baggage inspection applications and in medical applications for the detection of diseases, which modify the molecular structure of tissue.

Coherent-scatter computed tomography is a reconstructive x-ray imaging technique that yields the specially resolved coherent-scatter cross-section of the investigated object, i.e. for each object voxel with indices (i,j) in the measured slice a function dσ/dΩ (i,j,x) is reconstructed. Since the coherent scatter process is a rather unlikely event, a high photon flux or elongated measurement times are required.

According to an exemplary embodiment of the present invention, the exposure time may be reduced, as has been described above.

Two exemplary embodiments of the present invention are now described in more detail.

Using the pre-scanner to adjust the generator voltage:

A fan-beam CSCT-scanner may be equipped with a pre-scanner, which measures transmission images of the object of interest. From these images a selection scheme may select positions at which CSCT slices are measured in a subsequent scan.

Furthermore, the information gained by the pre-scanner may also be used for adjusting the voltage of the high-voltage generator of the CSCT-scanner within a given range. A high-voltage may only be adjusted with a long time constant. Therefore, the voltage may be calculated and changed prior to starting the scan of a slice.

In general, a lower voltage (e.g. 120 keV) with higher current (i.e. with constant power) may be advantageous for less dense (and thus less absorbing) suitcases, whereas a higher voltage (e.g. 180 keV) may be more appropriate for a denser suitcase.

A single transmission image may be used to calculate an approximate average attenuation. A pre-determined table or formula may then be used to calculate the optimum voltage for the CSCT scan. If a multi-view pre-scanner is used, a more accurate determination of the voltage may be achieved.

Using a multi-view pre-scanner to calculate the x-ray tube current modulation:

When a rotating anode x-ray tube is used, it may be possible to change the electron beam current within the tube quickly during rotation. Therefore, current modulation and thus different exposure doses may be achievable within one rotation.

According to an exemplary embodiment of the present invention, the beam current may be modulated such that a maximum value is reached when the object under investigation is viewed from a direction with maximum absorption and vice versa. By doing so, all projections may have a more even statistical behaviour and consequently the quality of the reconstructed image may be improved.

To calculate the optimum current modulation, a cross-sectional image of the attenuation properties of the object is required. This may be estimated from a multi-view pre-scanner or exactly be determined during the CT scan. A CT scan may be acquired in a single rotation, whereas for a CSCT slice it may be required to use several revolutions to measure enough photons.

Referring now to FIG. 3, an exemplary embodiment of a method for tube current modulation is described in greater detail, according to an exemplary embodiment of the present invention.

In step 1, the method starts by moving the radiation source along a circular source path and by emitting an electromagnetic radiation beam to the object of interest.

If no pre-scanner is present or if the pre-scanner does not allow for an estimation of a cross-sectional image of the object's attenuation property, a constant current is used during the first revolution of the source.

If the pre-scanner allows an estimation of the object's attenuation properties, this information is used to estimate a first guess of current modulation.

Then, in step 2, these initial values are used for the measurement of a CT-slice (first data acquisition during the first revolution of the radiation source). This data is then used to reconstruct the image. At the same time, data for the subsequent CSCT reconstruction are already being collected.

Then, in step 3, an optimization of an acquisition parameter of a subsequent second data acquisition is performed on the basis of the acquired and reconstructed image and/or the CT projection data. In other words, the reconstructed CT image and/or the CT projection data are used to optimize the current modulation.

Then, in step 4, the current modulation is used for all subsequent revolutions of the CSCT scan at the given slice position until enough photons are collected.

Therefore, the CSCT image may have a better quality at a given total dose/exposure time. Alternatively, for an anticipated image quality, the measurement time may be reduced.

FIG. 4 shows an exemplary embodiment of an image processing device according to the present invention for executing an exemplary embodiment of the method in accordance with the present invention. The image processing device 400 depicted in FIG. 4 comprises a central processing unit (CPU) or image processor 401 connected to a memory 402 for storing an image depicting an object of interest, such as an item of baggage. The data processor 401 may be connected to a plurality of input/output network or diagnosis devices, such as a CT/CSCT device. The data processor 401 may furthermore be connected to a display device 403, for example, a computer monitor, for displaying information or an image computed or adapted in the data processor 401. An operator or user may interact with the data processor 401 via a keyboard 404 and/or other output devices, which are not depicted in FIG. 4.

Furthermore, via the bus system 405, it may also be possible to connect the image processing and control processor 401 to, for example, a motion monitor, which monitors a motion of the object of interest. For example, the motion sensor may be an exhalation sensor or an electrocardiogram unit.

The acquisition speed of CSCT is limited by the photon flux. One of the main factors influencing photon flux is the X-ray attenuation in the object, which can vary by orders of magnitude, particularly in baggage inspection applications. With current CT-scanners with sub-second gantry rotation times the acquisition of a single CSCT slice will require more than one revolution in the most cases.

According to an exemplary embodiment of the present invention, the number of required gantry rotations for a single slice is calculated ‘on the fly’, i.e. during the data acquisition (on the basis of pre-measured acquisition data).

The impact may be a more flexible data acquisition, which may increase the throughput of the scanner and push the dark-alarm limit to higher densities. For medical applications this may reduce the patient dose.

The combined CT and scatter information can be used for material identification in the case of baggage inspection applications and in medical applications for the detection of diseases, which modify the molecular structure of tissue.

For the reconstruction of images with high quality and low noise a sufficient number of photons has to be measured. On the other hand a too high number of photons increases the patient dose (medical applications) or reduces the throughput (baggage inspection). Therefore measurement time and/or tube power should be adjusted such that an optimum number of photons is measured.

Contemporary CT-scanners for medical applications as well as baggage inspection apply gantry speeds of 60-180 rpm. Photon flux calculations of CSCT predict that 1000 milliseconds will not be sufficient to collect a sufficient number of photons for tube power below 20 kW. This means, that more than one gantry revolution will be required for data acquisition of a single slice.

The measurement time and thus the number of revolutions may mainly depend on attenuation within the piece of baggage or the patient. According to an exemplary embodiment of the present invention, this number may be calculated on the basis of data acquired during the first data acquisition prior to the CSCT scan or even during the measurement. In what follows estimation schemes are described.

In the following, two exemplary embodiments of the invention for the calculation of the measurement time are described in greater detail:

According to the first embodiment, the measurement time is calculated from the transmitted photon flux:

During or prior to the CSCT scan conventional CT projections are acquired. Using sinogram data (as depicted in FIG. 5) or reconstructed images (as depicted in FIG. 6) the attenuation inside the object can be deducted. The attenuation can then be used to estimate the scatter photon flux and thus the estimated scan time by applying a pre-calculated formula. The estimated scan time can be based on the average attenuation inside the object or the maximum attenuation.

FIG. 5 shows a flow-chart of another exemplary embodiment of a method of examination of an object of interest according to the present invention.

In step 1, a CT scan is performed. Then, in step 2, the attenuation is measured from projection data. In step 3, the CSCT scan time, which corresponds to the number of revolutions, is calculated on the basis of the measured attenuation. In step 4, the CSCT scan is started for a preset time (or for a preset number of revolutions). In step 5, the CT/CSCT scan is reconstructed and analyzed. In step 6, it is determined, whether a threat is detected. If this is the case, an alarm is issued in step 7. If no threat is detected, the scanner/table is moved to the next position in step 8.

FIG. 6 shows a flow-chart of another exemplary embodiment of a method of examination of an object of interest according to the present invention.

In step 1, a CT scan is performed. The, in step 2, the CT data is reconstructed. Then, in step 3, the attenuation is measured from the reconstructed CT image. In step 4, the CSCT scan time, which corresponds to the number of revolutions, is calculated on the basis of the measured attenuation. In step 5, the CSCT scan is started for a preset time (or for a preset number of revolutions). In step 6, the CT/CSCT scan is reconstructed and analyzed. In step 7, it is determined, whether a threat is detected. If this is the case, an alarm is issued in step 8. If no threat is detected, the scanner/table is moved to the next position in step 9.

According to the second embodiment, the measurement time is calculated from the scatter photon flux:

Once the scatter data acquisition has been started the photon flux can be monitored. Two schemes are described below:

a) During the first revolution the photon flux is monitored and from the flux the required number of revolution is calculated (FIG. 7).

b) For each projection the scatter data is stored and added cumulatively during subsequent revolutions until enough photons are recorded (FIG. 8).

FIG. 7 shows a flow-chart of another exemplary embodiment of a method of examination of an object of interest according to the present invention, in which, during the first revolution, the photon flux is monitored and from the flux the required number of revolutions is calculated.

In step 1, CSCT data is measured for the first rotation. In step 2, it is determined, whether there have been collected enough photons. If the answer is “no”, the method continues with step 3. If the answer is “yes”, the method jumps to step 5.

In step 3, the number of additional revolutions of the gantry is calculated. In step 4, additional (second) data is measured. Then, in step 5, the CSCT scan is reconstructed and analyzed. In step 6, it is determined, whether a threat is detected. If this is the case, an alarm is issued in step 7. If no threat is detected, the scanner/table is moved to the next position in step 8.

FIG. 8 shows a flow-chart of another exemplary embodiment of a method of examination of an object of interest according to the present invention, in which, for each projection, the scatter data is stored and added cumulatively for each subsequent revolution until enough photons are recorded.

In step 1, the detector memory is cleared. Then, in step 2, CSCT data is measured for one revolution of the gantry. In step 3, detector data is added to the memory. In step 4, it is determined, whether there have been collected enough photons. If the answer is “no”, the method jumps back to step 2. If the answer is “yes”, the method continues with step 5, in which the CSCT scan is reconstructed and analyzed. In step 6, it is determined, whether a threat is detected. If this is the case, an alarm is issued in step 7. If no threat is detected, the scanner/table is moved to the next position in step 8.

The scan time (measured e.g. in number of revolutions) may be stored in a pre-defined table taking into account several measures (e.g. average and maximum attenuation, maximum and average scatter flux). The table may contain several entries depending on an alarm-level (high alarm level means longer exposure time and vice versa) (see FIGS. 9 and 10). Instead of a predefined table also a calculation formula may be used. The entries in the table or the formula may have to be determined by experiments.

The entries in the table or the coefficients of the formula may be changed during operation according to a learning scheme: If a certain set of parameters repeatedly result in false alarms due to a too low number of photons, the measurement time/number of revolutions is increased and stored for future operation. By doing so, the scanner adopts to local variations of suitcase content.

Exemplary embodiments of the inventions may be sold as a software option to CSCT scanner console, imaging workstations or PACS workstations.

It should be noted that the term “comprising” does not exclude other elements or steps and the “a” or “an” does not exclude a plurality and that a single processor or system may fulfill the functions of several means or units recited in the claims. Also elements described in association with different embodiments may be combined.

It should also be noted, that any reference signs in the claims shall not be construed as limiting the scope of claims.

1. A computer tomography apparatus for examination of an object of interest comprising:
a radiation source for moving along a source path and for emitting an electromagnetic radiation beam to the object of interest;
a detector unit for acquiring separately scattered and transmitted radiation data from the object of interest; and
a calculation unit for performing an optimization of an acquisition parameter of a subsequent second data acquisition on the basis of radiation data acquired during a first data acquisition.

2. The computer tomography apparatus of claim 1, wherein the first data acquisition is performed during a full or partial first rotation of the radiation source using the detection unit.

3. The computer tomography apparatus of claim 1, wherein the acquisition parameter corresponds to a flux of the radiation source; and wherein the computer tomography apparatus is adapted for modulating a flux output of the radiation source on the basis of the acquired radiation data.

4. The computer tomography apparatus of claim 1, wherein the optimization of the acquisition parameter of the subsequent second data acquisition is performed on the basis of at least one of projection data resulting from the first data acquisition.

5. The computer tomography apparatus of claim 1, wherein the optimization of the acquisition parameter of the subsequent second data acquisition is performed on the basis of a reconstructed image resulting from the first data acquisition.

6. The computer tomography apparatus of claim 3, wherein the flux output modulation is performed such that a maximum value is reached when the object of interest is viewed from a direction with maximum absorption.

7. The computer tomography apparatus of claim 3, wherein the calculation unit is adapted for calculating an optimum flux output modulation on the basis of a cross-sectional image of attenuation properties of the object of interest.

8. The computer tomography apparatus of claim 1, wherein the first data acquisition is performed using a pre-scanner for measuring a pre-scan of the object of interest; and wherein the acquisition parameter optimization is based on pre-scan data.

9. The computer tomography apparatus of claim 8, wherein the pre-scanner is a multi-view pre-scanner.

10. The computer tomography apparatus of claim 1, further comprising:
a high-voltage generator;
wherein the acquisition parameter corresponds to a voltage of the high-voltage generator; and
wherein the computer tomography apparatus is adapted for determining the voltage on the basis of the acquired radiation data.

11. The computer tomography apparatus of claim 10, wherein the calculation unit is adapted for:
calculating an approximate average attenuation on the basis of a single transmission image; and
calculating the optimized voltage for the subsequent second data acquisition on the basis of the approximate average attenuation.

12. The computer tomography apparatus of claim 1, wherein the computer tomography apparatus is one of the group consisting of a fan-beam coherent scatter computed tomography apparatus, a cone-beam coherent scatter computed tomography apparatus, and a direct tomography coherent scatter computed tomography apparatus.

13. The computer tomography apparatus of claim 8, wherein the acquisition parameter corresponds to a position at which a coherent scatter computed tomography slice is measured during the subsequent second data acquisition.

14. (canceled)

15. (canceled)

16. The computer tomography apparatus of claim 1, wherein the acquisition parameter corresponds to a scan time of the subsequent second data acquisition; and wherein the optimization of the acquisition parameter of the subsequent second data acquisition is performed on the basis of a transmitted photon flux.

17. The computer tomography apparatus of claim 16, wherein the scan time is defined by multiplying the scan time of a single revolution with the number of revolutions used for the subsequent second data acquisition.

18. (canceled)

19. The computer tomography apparatus of claim 1, wherein the acquisition parameter corresponds to a scan time of the subsequent second data acquisition; and wherein the optimization of the acquisition parameter of the subsequent second data acquisition is performed on the basis of a scatter photon flux.

20. The computer tomography apparatus of claim 19, wherein the scatter photon flux is monitored during the first revolution of the gantry and from the scatter photon flux the required number of revolution is calculated.

21. The computer tomography apparatus of claim 19, wherein the scatter photon flux is stored for each projection and added cumulatively for each subsequent revolution until enough photons are recorded.

22. A method of examining an object of interest comprising:
emitting an electromagnetic radiation beam to the object of interest;
acquiring during a first data acquisition radiation data from the object of interest;
performing an optimization of an acquisition parameter of a subsequent second data acquisition on the basis of radiation data acquired during the first data acquisition, and
acquiring during a second data acquisition separately scattered and transmitted radiation data from the object of interest.

23. An image processing device for examining an object of interest comprising:
a memory for storing radiation data acquired, during a first data acquisition, separately scattered and transmitted from the object of interest; and
a calculation unit for performing an optimization of an acquisition parameter of a subsequent second data acquisition on the basis of radiation data acquired during the first data acquisition.

24. (canceled)

25. (canceled)
